(19) United States
(12) Patent Application Publication
(10) Pub. No.: US 2025/0121225 A1
(43) Pub. Date: Apr. 17, 2025

(54) UPPER COVER FOR BATTERY SYSTEM ASSEMBLY

(71) Applicant: HYUNDAI MOBIS CO., LTD., Seoul (KR)

(72) Inventor: Hoo Sik SIM, Yongin-si (KR)

(73) Assignee: HYUNDAI MOBIS CO., LTD., Seoul (KR)

(21) Appl. No.: 18/804,576

(22) Filed: Aug. 14, 2024

(30) Foreign Application Priority Data
Oct. 17, 2023 (KR) 10-2023-0138701

(51) Int. Cl. A62C 3/16; A62C 35/10; H01M 50/276; H01M 50/278; H01M 50/28

(52) U.S. Cl. CPC A62C 3/16; A62C 35/10; H01M 50/276; H01M 50/278; H01M 50/28; H01M 2200/10; H01M 2220/20

(57) ABSTRACT

An upper cover for a battery system assembly according to an embodiment of the present invention may include a cover body mounted on top of the battery assembly system, a fire tube disposed through the interior of the cover body and filled with a fire extinguishing solution, and a plurality of fire valves disposed in the fire tube and configured to open by combustion upon exposure to heat to cause the fire extinguishing solution to be discharged.

### CROSS-REFERENCE TO RELATED APPLICATION

The present application claims priority to Korean Patent Application No. 10-2023-0138701, filed Oct. 17, 2023, the entire contents of which is incorporated herein for all purposes by this reference.

### BACKGROUND OF THE INVENTION

### Field of the Invention

The present invention relates to an upper cover for a battery system assembly, and more particularly to an upper cover for a battery system assembly mounted to cover the upper surface of the battery system assembly.

### Description of the Related Art

An upper cover for a battery system assembly (BSA) mounted in electric vehicles is currently made of a galvanized steel sheet. The galvanized steel sheet has insulation coatings, but the insulation property is lost when the galvanized steel sheet is exposed to an open fire.

The battery system assembly utilizes lithium-ion batteries, which are inherently susceptible to external impact and heat, and thermal runaway occurs if a cell ruptures. One potential cause of the thermal runaway is the sparking caused by a short circuit occurring when the insulation on the busbars connecting the battery modules is compromised. In other words, the conventional metal upper cover is made of conductive metal so that a short circuit to a stripped busbar occurs, leading to sparking. This sparking exacerbated thermal runaway.

In the event of a fire in an electric vehicle, the insulation of the upper cover is crucial to preventing thermal runaway, and there is a need to develop technology that enables the prevention of fire spread even when a fire occurs.

### SUMMARY OF THE INVENTION

An embodiment of the present invention provides an upper cover for a battery system assembly that utilizes a synthetic resin as the material of the cover body to resolve the issue of a short-circuit to a busbar fundamentally.

In addition, an embodiment of the present invention provides an upper cover for the battery system assembly that includes a metal fire tube filled with fire extinguishing solution and disposed within the cover body and causes the fire extinguishing solution to be discharged when heat from a fire is transferred to the tube, thereby preventing thermal runaway. The issues that the present invention intends to resolve

are not limited to the above-mentioned issues, and other issues not mentioned herein may be clearly understood by those skilled in the art from the following description.

An upper cover for a battery system assembly according to an embodiment of the present invention may include a cover body that may be configured to be mounted on top of the battery system assembly, a fire tube extending through an interior of the cover body and containing therein a fire extinguishing solution, and a plurality of fire valves disposed in the fire tube and configured to open in response to combustion upon exposure to heat to cause the fire extinguishing solution to be discharged from the fire tube.

The plurality of fire valves may be at least partially exposed at an outside of the cover body, and configured to close and open corresponding discharge holes positioned along the fire tube.

The fire tube may be comprised of a metal and the fire valve may be comprised of a synthetic resin.

One or more fire valves of the plurality of fire valves may include a valve body coupled to a bottom of the fire tube and having a corresponding discharge hole formed an end thereof and a valve diaphragm positioned on an inner side of the end of the valve body and configured to open by combustion upon exposure to heat to cause the fire extinguishing solution to be discharged.

The valve diaphragm may include a valve diaphragm body having a generally cuboid shape and an attenuated diaphragm portion recessed in the center of the valve diaphragm body.

The fire tube may be disposed in a zigzag pattern inside the cover body.

A fire extinguishing solution tank supplying the fire extinguishing solution may be connected to one end of the fire tube, and the fire extinguishing solution tank may be configured to be disposed within the battery system assembly.

The cover body may comprise a synthetic resin that includes at least one of a fire retardant and fiberglass.

The cover body may include a first body portion and a second body portion attached to a top of the first body portion, and the fire tube may be disposed on the top of the first body portion and enclosed by the first and second body portions. The cover body may be manufactured through compression

molded in a state where the second body portion is disposed on top of the first body portion and the fire tube.

### BRIEF DESCRIPTION OF THE DRAWINGS

FIG. 1 is a perspective view illustrating an upper cover for a battery system assembly according to an embodiment of the present invention.

FIG. 2 is a view illustrating a fire tube disposed on top of a battery system assembly according to an embodiment of the present invention.

FIG. 3 is a longitudinal view illustrating a fire tube and a fire valve in an upper cover for a battery system assembly according to an embodiment of the present invention.

FIG. 4 is a longitudinal view illustrating a fire valve combusting to cause a fire extinguishing solution to be discharged from a fire tube in an upper cover for a battery system assembly according to an embodiment of the present invention.

FIG. 5 is a cross-sectional view illustrating an upper cover for a battery system assembly according to an embodiment of the present invention.

FIGS. 6 and 7 are views illustrating a manufacturing process of an upper cover for a battery system assembly through compression molding according to an embodiment of the present invention.

FIGS. 8 and 9 are views illustrating a manufacturing process of an upper cover for a battery system assembly through injection molding according to an embodiment of the present invention.

FIGS. 10 and 11 are views illustrating a manufacturing process of an upper cover for a battery system assembly according to another embodiment of the present invention.

FIG. 12 is a bottom view illustrating a jig structure for supporting the manufacturing of an upper cover for a battery system assembly according to another embodiment of the present invention.

FIG. 13 is a cross-sectional view illustrating an example of a fire valve of an upper cover for a battery system assembly according to another embodiment of the present invention.

FIG. 14 is a plan view illustrating an example of a fire valve of an upper cover for a battery system assembly according to another embodiment of the present invention.

### DETAILED DESCRIPTION OF THE INVENTION

The present invention is subject to various modifications and may have several embodiments, and specific embodiments will be illustrated in the drawings and described. However, it is not intended to limit the present invention to those specific embodiments, and it is to be understood that all modifications, equivalents, or substitutes that fall within the scope of the spirit and technology of the present invention are included. When it is determined that a specific description of the widely known technology may obscure the gist of the present invention in describing the present invention, a detailed description thereof will be omitted.

Terms such as the first, second, and the like may be used to describe various components, but the components are not to be limited to those terms. The terms are used only to distinguish one component from the other.

The terms used herein are used only to describe specific embodiments and are not intended to limit the present invention. Singular expressions include plural expressions unless the context clearly means otherwise. In the present application, terms such as “comprise” or “have” are intended to indicate the presence of implemented features, numbers, steps, manipulations, components, parts, or combinations thereof described herein and are not to be understood to preclude the presence or additional possibilities of one or more of other features, numbers, steps, manipulations, components, parts or combinations thereof.

In addition, throughout the specification, the term “connected” does not only mean the direct connection between two or more components but includes indirect connections of two or more components through additional components, physical connections as well as electrical connections, and integrations of components assigned different names depending on their positions or functions.

In addition, when each component is described as being formed or disposed “on (above) or under (below)”, it includes cases where the two components are in direct contact with each other as well as cases where one or more additional components are formed or disposed between the two components. In addition, the expression “on (above) or under (below)” may also include both upward and downward directions with respect to one component.

An embodiment of an upper cover for a battery system assembly according to the present invention will be described in detail with reference to the accompanying drawings in the following. In describing the invention with reference to the accompanying drawings, the same or corresponding components will be assigned the same reference numeral and repetitive description thereof will be omitted.

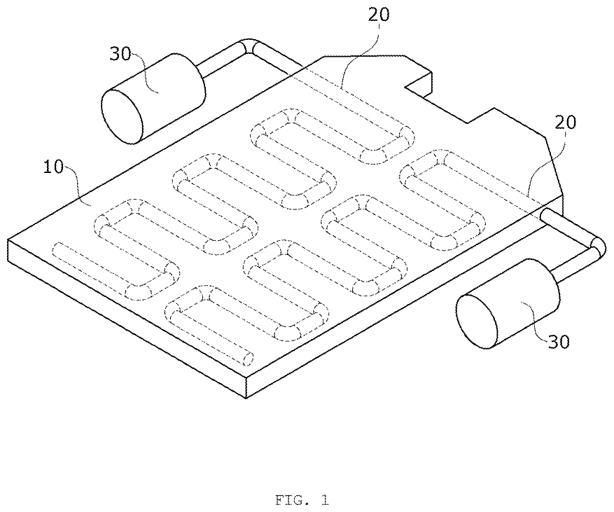

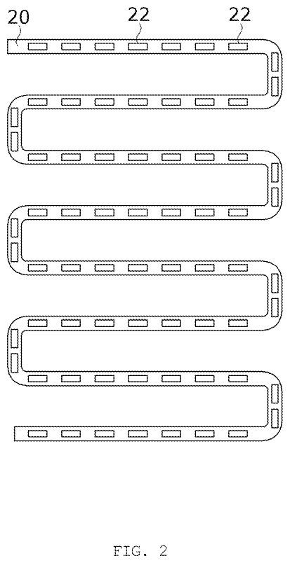

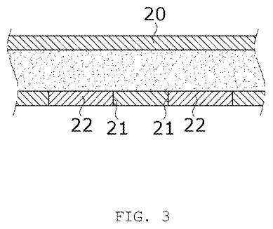

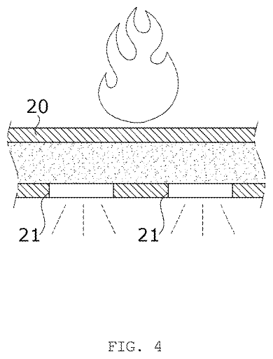

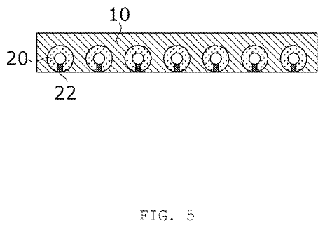

FIG. 1 is a perspective view illustrating an upper cover for a battery system assembly according to an embodiment of the present invention, FIG. 2 is a view illustrating a fire tube disposed on top of a battery system assembly according to an embodiment of the present invention, FIG. 3 is a longitudinal view illustrating a fire tube and a fire valve in an upper cover for a battery system assembly according to an embodiment of the present invention, FIG. 4 is a longitudinal view illustrating a fire valve combusting to cause a fire extinguishing solution to be discharged from a fire tube in an upper cover for a battery system assembly according to an embodiment of the present invention, and FIG. 5 is a cross-sectional view illustrating an upper cover for a battery system assembly according to an embodiment of the present invention.

The drawings show that an upper cover for a battery system assembly may include a cover body 10 mounted on top of the battery system assembly, a fire tube 20 disposed through the interior of the cover body and filled with a fire extinguishing solution, and a plurality of fire valves 22 disposed in the fire tube 20 and configured to open by combustion upon exposure to heat to cause the fire extinguishing solution to be discharged.

The upper cover for protecting batteries disposed inside a battery system assembly may be mounted on top of the battery system assembly. For the convenience of description, the upper cover illustrated in FIG. 1 is thicker than the actual upper cover. The actual upper cover may have a relatively reduced thickness compared to the upper cover illustrated in FIG. 1.

The cover body 10 has a generally cuboid shape (e.g., a rectangular plate shape) that allows the cover body to cover the top surface of the battery system assembly. The cover body 10 was conventionally made of metal. However, when the cover body 10 is made of metal in this manner, the problem is that a short circuit to a stripped busbar occurs, leading to sparking that exacerbates thermal runaway in the event of a fire. Therefore, in the present embodiment, synthetic resin is utilized as the material of the cover body 10 to resolve the issue of a short circuit to the busbar fundamentally. For example, the cover body 10 may be made of synthetic resin that includes fire retardant and fiberglass.

Thermal runaway may be prevented by disposing the metal fire tube 20 filled with a fire extinguishing solution inside the cover body. In addition, when the fire tube 20 is made of metal, it may reinforce the strength of the cover body 10 made of synthetic resin.

The fire tube 20 is disposed through the interior of the cover body 10, and a plurality of fire tubes 20, each having a single flow path, may be disposed. For example, two fire tubes 20 may be disposed in a zigzag pattern inside the cover body 10. A fire extinguishing solution tank 30 may be connected to an end of the zigzagged fire tube 20. The fire extinguishing solution tank 30 supplies the fire extinguishing solution into the fire tube 20. As illustrated in the drawing, the fire extinguishing solution tank 30 may be disposed outside the cover body 10, and in this case, the tank may be disposed in a space available for mounting in the battery system assembly. In addition, although not specifically illustrated in the drawing, the fire tube 20 may also be disposed in a grid pattern inside the cover body 10.

FIGS. 2 to 4 show that a plurality of fire valves 22 may be provided at predetermined intervals on the outer surface of the fire tube 20. The fire valve 22 may be mounted to close the discharge hole 21 formed on the outer surface of the fire tube 20. The fire valve 22 provided in this manner may be made of synthetic resin that may combust at high temperatures. This is to ensure that the fire valve 22 melts and combusts due to the fire when a fire occurs in the battery system assembly as shown in FIG. 4 and that the fire extinguishing solution is discharged downward to the battery system assembly through the opened discharge hole 21.

As illustrated in FIG. 2, a plurality of fire valves 22 may be disposed along the outer surface of the fire tube 20. When the fire valves 22 are disposed along the fire tube 20 in this manner, the fire valves 22 disposed in the vicinity of a fire may melt and combust, causing the discharge holes 21 to open so that it is possible to cope with the fire at various locations. The fire valve 22 may be attached to the discharge hole 21 of the fire tube 20 using a clamp or screw to withstand the pressure of at the fire extinguishing solution room temperature or temperature below the room temperature. The fire valve 22 may be disposed at the bottom of the fire tube 20 to cause the fire extinguishing solution to be discharged downward.

FIG. 5 shows that the fire valve 22 may be disposed to be exposed to the outside of the cover body 10. Such exposure to the outside of the cover body 10 allows the fire valve 22 to melt upon directly receiving heat from fires in the event of a fire in the vicinity so that the discharge of the fire extinguishing solution is facilitated. However, since direct exposure to the outside carries the risk of unintended combustion of the fire valve 22 under certain conditions, the fire valve 22 may be disposed to be partially, rather than wholly, exposed. In addition, the drawing illustrates that only fire valve 22 is exposed to the outside of the cover body 10, but the exposure is not limited thereto. The bottom surface of the fire tube 20 may be partially exposed together with the fire valve 22.

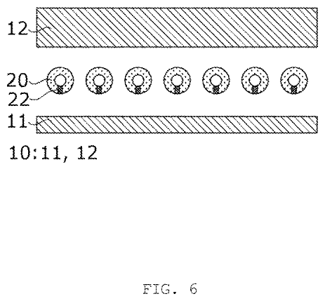

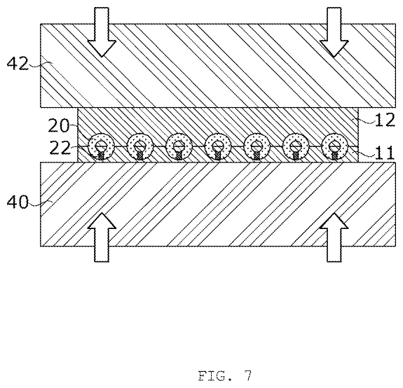

FIGS. 6 and 7 are views illustrating a manufacturing process of an upper cover for a battery system assembly through compression molding.

This embodiment relates to the manufacturing of the upper cover through compression molding. First, as illustrated in FIG. 6, the cover body 10 may include a first body portion 11, the fire tube 20 disposed on top of the first body portion 11, and a second body portion 12 attached to the top of the first body portion 11 to enclose the fire tube 20.

In this embodiment, the cover body 10 mainly includes the first body portion 11 and the second body portion 12. Each of the first body portion 11 and the second body portion 12 is used to manufacture the upper cover through a compression molding process using the thermosetting resin. Here, for example, the first body portion 11 may be made of a composite material that includes a long fiber of 1 mm or longer while the second body portion 12 may be made of a composite material that includes a fabric of 2 mm or thicker.

When the second body portion 12 is pressed at a high temperature by the top compression mold 42 on top of the bottom compression mold 40 as illustrated in FIG. 7 in a state where the fire tube 20 is disposed between the first body portion 11 and the second body portion 12, an upper cover with the fire tube 20 disposed on the inner side of the cover body 10 may be manufactured.

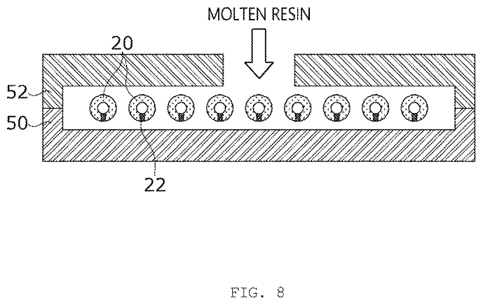

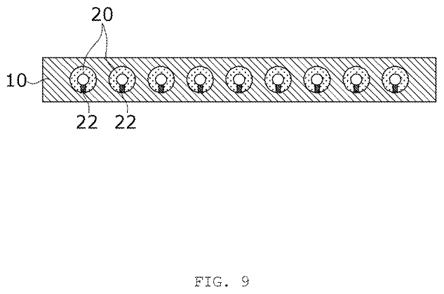

FIGS. 8 and 9 are view illustrating a manufacturing process of an upper cover for a battery system assembly through injection molding according to an embodiment of the present invention.

This embodiment relates to the manufacturing of the upper cover through injection molding. As illustrated in FIG. 8, a frame is formed inside a mold consisting of a bottom injection mold 50 and a top injection mold 52, and a fire tube 20 is disposed inside.

Next, an operator injects molten resin into a cavity formed by the bottom injection mold 50 and the top injection mold 52, and an upper cover may be manufactured as illustrated in FIG. 9 when the molten resin solidifies. At this time, fire retardant and fiberglass may make up 30-50% of the molten resin to ensure the strength of the upper cover, for example.

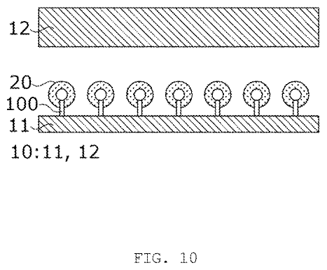

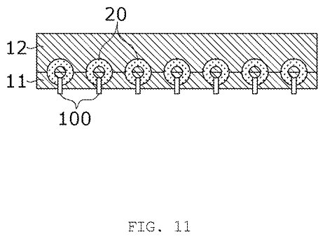

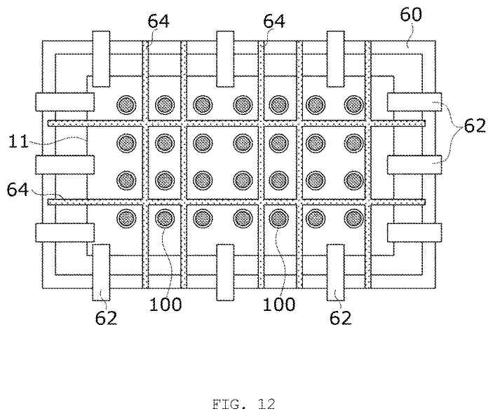

FIGS. 10 and 11 are views illustrating a manufacturing process of an upper cover for a battery system assembly according to another embodiment of the present invention, and FIG. 12 is a bottom view illustrating a jig structure for supporting the manufacturing of an upper cover for a battery system assembly according to another embodiment of the present invention.

In this embodiment, the cover body 10 includes the first body portion 11 and the second body portion 12 and may be manufactured by laminating the first body portion 11, the second body portion 12, the fire tube 20, and a fire valve 100. In other words, the cover body 10 may be manufactured in a state where the fire tube 20 and the fire valve 100 are disposed between the first body portion 11 and the second body portion 12. At this time, the fire valve 100 may be exposed downward from the bottom side of the first body portion 11 as illustrated in FIG. 11.

A jig 60 supports the first body portion 11 in the manufacturing of the upper cover. In other words, the jig 60 may have a larger frame than the first body portion 11 and may be disposed around the outer edge of the first body portion 11. The jig 60 may be provided with a clamp 62 for supporting the edge of the first body portion 11, and a plurality of clamps 62 may be disposed on the jig 60 to enclose the first body portion 11. The clamp 62 extends towards the edge of the first body portion 11 to support the first body portion 11. In addition, a plurality of support guides 64 may be disposed across the jig 60. The jig guides 64 traverse the jig, ensuring they do not interfere with the fire valves 100, and support the bottom surface of the first body portion 11, preventing sagging of the first body portion 11 during the manufacturing process.

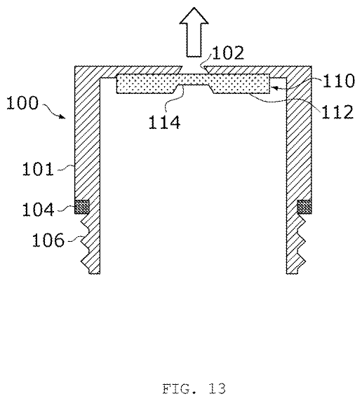

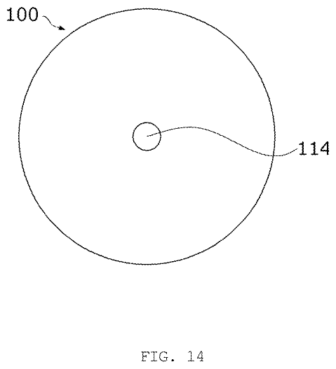

FIG. 13 is a cross-sectional view illustrating an example of a fire valve of an upper cover for a battery system assembly according to another embodiment of the present invention, and FIG. 14 is a plan view illustrating an example of a fire valve of an upper cover for a battery system assembly according to another embodiment of the present invention.

FIGS. 13 and 14 show that the fire valve 100 may include a valve body 101 fastened to the bottom of the fire tube 20 to have a discharge hole 102 at its end and a valve diaphragm 110 provided on the inner side of the end of the valve body 101 and configured to open by combustion upon exposure to heat to cause the fire extinguishing solution to be discharged. The valve body 101 is made of metal in a pipe shape, and the valve diaphragm 110 is made of easily combustible synthetic resin.

An O-ring 104 may be provided on the outer circumferential surface of the valve body 101 to prevent leakage of the fire extinguishing solution, and a thread 106 may be formed for fastening the O-ring with the fire tube 20.

In this embodiment, an open discharge hole 102 is formed at the end, that is, in the center of the bottom portion, of the valve body 101 in the valve diaphragm 110. The valve diaphragm 110 may be welded to the inner side of the end of the valve body 101 using laser irradiation to close the discharge hole 102. Of course, the value diaphragm 110 may be attached to the valve body 101 by other means.

On the other hand, the valve diaphragm 110 is formed in a thin plate and may include a body diaphragm body 112 and an attenuated diaphragm portion 114 recessed in the center of the valve diaphragm body 112 to have a relatively reduced thickness compared to the surrounding valve diaphragm body 112. Since the attenuated diaphragm portion 114 is thinner than the valve diaphragm body 112, the valve diaphragm portion 114 more easily combusts upon exposure to a fire to facilitate the discharge of the fire extinguishing solution. The attenuated diaphragm portion 114 may be provided at a position facing the discharge hole 102 and may be designed to be larger in diameter than the discharge hole 102.

According to an embodiment of the present invention, the synthetic resin may be utilized as the material of the cover body to resolve the issue of a short circuit to a busbar fundamentally.

In addition, according to an embodiment of the present invention, a metal fire tube filled with a fire extinguishing solution may be disposed inside the cover body to combust upon exposure to heat from fires and cause the fire extinguishing solution to be discharged, thereby preventing thermal runaway.

While description has been made with reference to specific embodiments of the present invention above, it will be understood by those skilled in the art that various modifications and alterations may be made to the invention without departing from the spirit and scope of the present invention as disclosed in the following patent claims.

DESCRIPTION OF REFERENCE NUMERALS

| | |
|---|---|
| 10: cover body | 11: first body portion |
| 12: second body portion | 20: fire tube |
| 21: discharge hole | 22: fire valve |
| 30: fire extinguishing solution tank | |
| 40: bottom compression mold | |
| 42: top compression mold | |
| 50: bottom injection mold | |
| 52: top compression mold | 60: jig |
| 62: clamp | 64: support guide |
| 100: fire valve | 101: valve body |
| 102: discharge hole | 104: O-ring |
| 106: thread | 110: valve diaphragm |
| 112: valve diaphragm body | |
| 114: attenuated diaphragm portion | |

What is claimed is:

1. An upper cover for a battery system assembly, the upper cover comprising:
a cover body;
a fire tube extending through an interior of the cover body and containing therein a fire extinguishing solution; and
a plurality of fire valves disposed in the fire tube and configured to open in response to combustion upon exposure to heat to cause the fire extinguishing solution to be discharged from the fire tube.

2. The upper cover of claim 1, wherein the plurality of fire valves are at least partially exposed at an outside of the cover body, and are configured to close and open corresponding discharge holes positioned along the fire tube.

3. The upper cover of claim 1, wherein the fire tube is comprised of a metal and the plurality of fire valves are comprised of a synthetic resin.

4. The upper cover of claim 1, wherein one or more fire valves of the plurality of fire valves comprises:
a valve body coupled to a bottom of the fire tube and having a corresponding discharge hole formed at an end thereof; and
a valve diaphragm positioned on an inner side of the end of the body valve and configured to open by combustion upon exposure to heat to cause the fire extinguishing solution to be discharged.

5. The upper cover of claim 4, wherein the valve diaphragm comprises:
a valve diaphragm body having a generally cuboid shape; and
an attenuated diaphragm portion recessed in a center of the valve diaphragm body.

6. The upper cover of claim 1, wherein the fire tube is disposed in a zigzag pattern inside the cover body.

7. The upper cover of claim 1, wherein a fire extinguishing solution tank supplying the fire extinguishing solution is connected to one end of the fire tube, and wherein the fire extinguishing solution tank is configured to be disposed within the battery system assembly.

8. The upper cover of claim 1, wherein the cover body comprises of synthetic resin that includes at least one of a fire retardant and fiberglass.

9. The upper cover of claim 1, wherein the cover body includes a first body portion and a second body portion attached to a top of the first body portion, and
wherein the fire tube is disposed on the top of the first body portion and enclosed by the first and second body portions.

10. The upper cover of claim 9, wherein the cover body is manufactured through compression molding in a state where the second body portion is disposed on top of the first body portion and the fire tube.

11. The upper cover of claim 1, wherein the cover body is configured to be mounted on top of a battery system assembly.
